(19) United States
(12) Patent Application Publication
(10) Pub. No.: US 2007/0018787 A1
(43) Pub. Date: Jan. 25, 2007

(54) SYSTEMS AND METHODS FOR SECURE LOCKING MECHANISMS

(75) Inventors: Francisco Martinez de Velasco Cortina, Condesa, CA (MX); Enrique Martinez de Velasco, Mexico City (MX); Eric Mikuteit, San Diego, CA (US); Jun Lui, San Diego, CA (US)

Correspondence Address: BAKER & MCKENZIE LLP;PATENT DEPARTMENT, 2001 ROSS AVENUE, SUITE 2300, DALLAS, TX, 75201, US

(73) Assignee: NEOLOGY, INC., San Diego, CA (US)

(21) Appl. No.: 11/459,598

(22) Filed: Jul. 24, 2006

Related U.S. Application Data
(60) Provisional application No. 60/701,793, filed on Jul. 22, 2005.

(51) Int. Cl. G05B 19/00; B60R 25/00

(52) U.S. Cl. 340/5.61; 340/5.73

(57) ABSTRACT

A locking system can include an RFID lock that can include a shackle and a body that can, for example, be steel, or other materials commonly used to produce locks, such as metal alloys, etc. The shackle can be pressed into the body and locked into place by an electronic piston. When the RFID lock is to be unlocked, an electronic piston can release the shackle allowing the lock to be opened. Unlike conventional locks, however, the electronic piston can be controlled by an RFID reader. The electronic piston can be opened when the RFID reader reads an RFID enabled key that is configured to unlock the RFID lock. In other words, specific RFID enabled keys can be configured to open the RFID lock analogously to the way that specific keys can be cut to configure the key to open a specific lock.

### RELATED APPLICATIONS

This application is based upon and claims the benefit of priority from U.S. Provisional Patent Application Ser. No. 60/701,793, filed Jul. 22, 2005, the entire contents of which are incorporated herein by reference.

### BACKGROUND

1. Field of the Invention

The present invention relates generally to Radio Frequency Identification Technology (RFID), and more particularly to secure locking mechanisms that use RFID to control access.

2. Background of the Invention

RFID systems can include several components including, RFID tags, RFID tag readers, RFID tag programmers, etc. The RFID system can allow data to be transmitted by the RFID tag to an RFID reader when the RFID reader interrogates the RFID tag. The information transmitted from the tag to the reader can be used or processed in many different ways depending on the particular application. For example, an RFID tag can provide identification information, or information about a product to which the tag is affixed, such as the price of the product.

Generally, in an RFID system, individual objects are equipped with an RFID tag. The RFID tag can contain a transponder that can include a digital memory chip that can be given a unique electronic code. The RFID reader can transmit a signal activating the RFID tag and allowing it to be read and written with data. For example, when an RFID tag passes through an RFID reader, the RFID tag can detect a signal from the reader and can transmit data from the tag to the reader in response. The reader can then decode the data transmitted by the tag. This information can then by used by the RFID system to perform whatever function the system is designed to perform. For example, an RFID system in a store can be used to track merchandise.

RFID tags can come in two basic types; passive, or active. Passive RFID tags do not include their own power supply. A small amount of electrical current is induced in the antenna by an incoming radio frequency signal produced by the reader. This current can then be used to provide power so that the tag can transmit a response when it is interrogated by the RFID reader. This power can be limited, therefore, the response may need to be short. Further, the inherent power limitations of passive tags can limit the transmit range of the tag.

On the other hand, active RFID tags have a power source, and can have larger memories and/or longer ranges than passive tags. While active tags can, in some cases have more capabilities when compared to passive tags, passive tags are generally much cheaper to manufacture than active tags and they do not need a battery. Thus, passive tags are generally much smaller and less costly, making them preferable for many applications.

### SUMMARY

A locking system can include an RFID lock that comprises a locking mechanism and an RFID reader. The locking mechanism can be unlocked when an RFID device configured to be an RFID key is brought into proximity of the RFID lock. For example, the RFID key can include an RFID tag. When the RFID tag is brought into proximity of the RFID reader, the lock can be opened. Additionally, the locking system can communicate through a communication network to a system that can, for example, be used to store information, such as which RFID enabled key(s) can open which RFID enabled lock(s). The data communicated between the RFID lock and the system can also include, for example, tracking information, configuration information, etc.

In one aspect the locking system can include an RFID lock that can include a shackle and a body. The shackle and body can, for example, be steel, however, other materials commonly used to produce locks, such as metal alloys, etc., can be used to form the shackle and body. Additionally, RFID lock technology is not limited to currently available metal alloys and materials for the shackle and body. The shackle can be pressed into the body and locked into place by an electronic piston. When the RFID lock is to be unlocked, an electronic piston can release the shackle allowing the lock to be opened. Unlike conventional locks, however, the electronic piston can be controlled by an RFID reader. The electronic piston can be opened when the RFID reader reads an RFID enabled key that is configured to unlock the RFID lock. In other words, specific RFID enabled keys can be configured to open the RFID lock analogously to the way that specific keys can be cut to configure the key to open a specific lock.

In another aspect, the RFID enabled key can be included in a card, wristband, or other device. Further, the RFID enabled key can be electronically configured rather than “cut” as a key is cut. It will further be understood that this electronic configuration can include tuning an antenna on RFID enabled key which can include some physical configuration of the antenna, such as milling or cutting various shapes, lengths, etc. for the antenna.

The locking system can be used to lock, e.g., a shipping container, trailers, railroad cars, or other lockable shipping devices. In fact RFID locks can be used in other applications that use conventional padlocks or similar locking devices. Examples of conventional padlocks or similar locking devices include, but are not limited to, vehicle security locks, towing locks, backpack locks, bike locks, outboard motor padlocks, gun locks, cable locks, and any of the various kinds and styles of padlocks.

Further, as explained below, the systems and methods described herein can be applied to other types of locks, such as car doors, hotel doors, doors to rooms at resorts, or on cruise ships, residence entry doors, business entry doors, etc. Essentially, the systems and methods described herein can be employed where entry and/or access needs to be restricted, e.g., where a traditional key or key type device may be used.

### BRIEF DESCRIPTION OF THE DRAWINGS

For a more complete understanding of the invention, and the advantages thereof, reference is now made to the following descriptions taken in conjunction with the accompanying drawings, in which:

FIG. 1 is a diagram illustrating an example shipping container and locking system in accordance with one embodiment;

FIG. 2 is a diagram illustrating the example locking system of FIG. 1 in more detail;

FIG. 3 is a flowchart illustrating an example method of locking and tracking in accordance with one embodiment;

FIG. 4 is a diagram illustrating an example third party RFID reader that can be connected to the system in FIG. 2; and

FIG. 5 is a flowchart illustrating an example method of paying a third party service provider.

### DETAILED DESCRIPTION

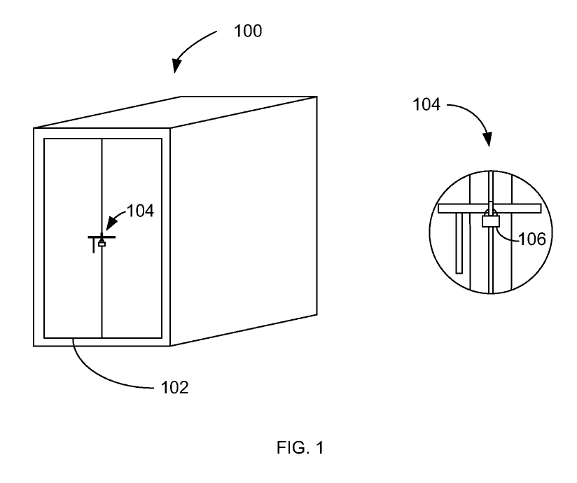

FIG. 1 is a diagram illustrating an example shipping container 100 and locking system in accordance with one embodiment of the systems and methods described herein. While an example shipping container 100 is illustrated, it will be understood that the systems and methods described herein can be used with shipping containers, trailers, railroad cars, or other lockable shipping devices. In fact, the systems and methods described herein can be applied whenever secure locking systems are needed. As discussed above, other examples include car doors, hotel doors, doors to rooms at resorts, or on cruise ships, residence entry doors, business entry doors, etc.

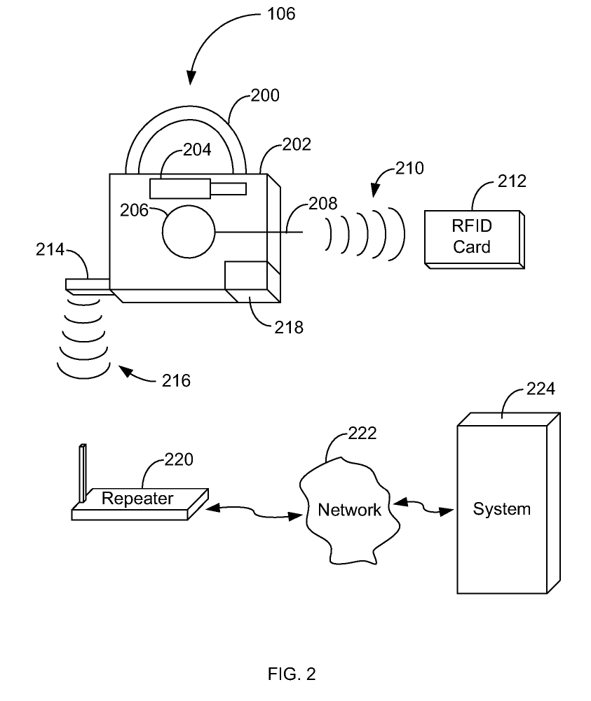

In one aspect, shipping container 100 can include one or more doors 102 that can allow access to its interior. The door or doors 102 can include a locking mechanism 104 that can allow doors 102 to be locked. In this way any items that are being shipped in shipping container 100 can be secured to help lower the probability of theft, etc. Locking mechanism 104 can be locked using an RFID lock 106. RFID lock 106 will be discussed further with respect to FIG. 2.

Again, it will be understood that shipping container 100 is one example application of the systems and methods described herein and that the systems and methods described herein can be used in conjunction with other lockable items, not just containers, trailers, railroad cars, or other lockable shipping devices. For example, it will be understood that while RFID lock 106 is shown used in conjunction with shipping container 100, RFID lock 106 can be used in other applications that use conventional padlocks or similar locking devices. Examples of conventional padlocks or similar locking devices include, but are not limited to, vehicle security locks, towing locks, backpack locks, bike locks, outboard motor padlocks, gun locks, cable locks and any of the various kinds and styles of padlocks. This list is not intended to be exhaustive.

Further, as explained below, the systems and methods described herein can be applied to other types of locks, such as car doors, hotel doors, doors to rooms at resorts, and on cruise ships, residence entries, business entry doors, etc. Essentially, the systems and methods described herein can be employed where entry and/or access needs to be restricted, e.g., where a traditional key or key type device may be used.

In embodiments that use position/location technology such as Global Positioning System (GPS) as described below, these locks can be used to help track and potentially recover stolen items. For example, if a backpack is stolen, but the lock is not removed from the backpack, then the RFID lock with position/location technology can be used to track and, in some cases, recover the stolen backpack. It will be understood that in cases when theft necessarily involves forcefully removing an RFID lock from an item, it can be difficult or impossible to track that item.

FIG. 2 is a diagram illustrating an example locking system in accordance with one embodiment of the systems and methods described herein. The locking system includes RFID lock 106 discussed above with respect to FIG. 1 that can include a shackle 200 and body 202. Shackle 200 and body 202 can, for example, be steel, however, other materials commonly used to produce locks, such as metal alloys, etc., can be used to form shackle 200 and body 202. Additionally, RFID lock technology is not limited to currently available metal alloys and materials for the shackle 200 and body 202. Shackle 200 can be pressed into body 202 and locked into place by electronic piston 204. When RFID lock 106 is to be unlocked, electronic piston 204 can release shackle 200 allowing the lock to be opened. Unlike conventional locks, however, electronic piston 204 can be controlled by an RFID reader 206. Electronic piston 204 can be opened when RFID reader 206 reads an RFID enabled key 212 that is configured to unlock RFID lock 106. In other words, specific RFID enabled keys 212 can be configured to open RFID lock 106 analogously to the way that specific keys can be cut to configure the key to open a specific lock.

It will be understood that generally, RFID enabled key 212 can be configured electronically rather than “cut” as a key is cut. It will further be understood that this electronic configuration can include tuning an antenna on RFID enabled key 212 which can include some physical configuration of the antenna, such as milling or cutting various shapes, lengths, etc. for the antenna.

RFID reader 206 can be an active device that transmits signals 210 by using antenna 208. RFID reader 206 can send and receive signals from RFID enabled key 212 through antenna 208 and when RFID reader 206 is close enough to RFID enabled key 212 then electronic piston 204 can be released and the lock can be opened. Recall that RFID enabled key 212 can be a card that is specifically configured to open RFID lock 106. Other RFID devices not so configured generally cannot open RFID lock 106, e.g., the other RFID enabled key can be configured to open other RFID locks, or alternatively, the other RFID enabled key can be an entirely different type of RFID device.

Generally, RFID lock 106 can include an internal power source, such as battery 218, to power the RFID circuits and any other circuits included in the lock 106. Other circuits can include, for example, an antenna and transceiver 214. Antenna and transceiver 214 can include RF systems, WIFI, GSM, GPS, GPRS, other types of systems, or a combination of multiple systems. It will further be understood that the antenna and transceiver 214 can be a receiver, transmitter, or both, depending on the specific application and embodiment.

For example, in one embodiment a combination of WIFI and GPS can be used. The GPS can provide position/location information and the WIFI can allow the lock to transmit the position/location information. For example, the lock can be set to transmit its position whenever it is moved. Other combinations, such as GPS and GSM are also possible.

Antenna and transceiver 214 can transmit and/or receive signals from repeater 220 that can be connected to network 222 and system 224. In this way, data can be communicated from RFID lock 106 to system 224, to RFID lock 106 from system 224, or both. This information can include tracking information, configuration information, including, e.g., which RFID enabled keys can open RFID lock 212, etc.

In one embodiment, RFID lock 106 can only be opened in a specific location, as determined, for example, by a GPS in conjunction with RFID enabled key 212. The location information can be stored, e.g., at system 224, in RFID lock 106, etc.

In the embodiment described above with respect to FIG. 2, RFID reader 206 can be located within RFID lock 106 and RFID enabled key 212 can be external to RFID lock 106. It will be understood, however, that the location of these devices can be reversed, e.g., an RFID lock can include an RFID enabled key and the RFID lock can be opened when, for example, a portable RFID reader is brought near the RFID tag located within the RFID lock.

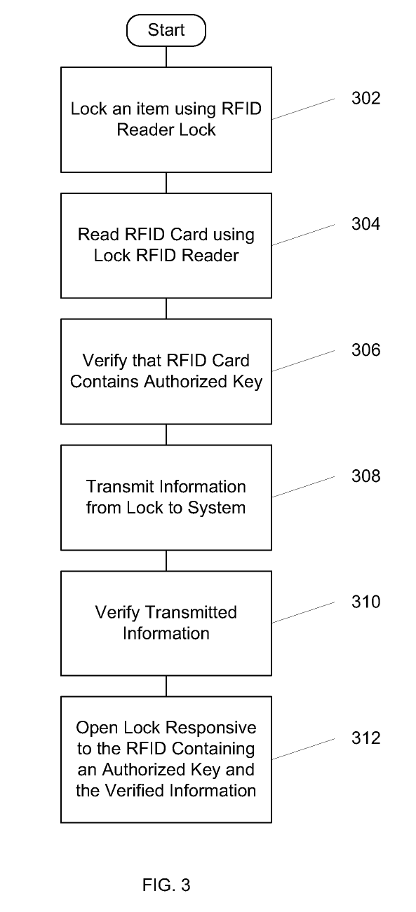

FIG. 3 is a flowchart illustrating an example of a method of locking items, such as shipping containers, car doors, hotel doors, in accordance with one embodiment of the methods described herein. In step 302 an item can be locked using RFID lock 106. For example, container 100 can be locked using RFID lock 106. Essentially an item to be locked can be any item that would use a key or key type system and a lock system, such as locking door knobs, padlocks, etc. Other items that can be locked include car doors, hotel doors, doors at resorts, doors at businesses, residence doors, etc. Examples that can use an padlock type RFID lock can include containers 100, tool boxes, gates, etc.

When locked container 100 needs to be unlocked an RFID enabled key 212 configured to open RFID lock 106 can be brought into proximity of the lock 106 and in step 304 the RFID reader 206 that can be inside RFID lock 106 can read RFID enabled key 212. In this way RFID enabled key 212 can be verified to determine that it contains an authorized key in step 306. The verification step can verify the key against data stored in the lock or against data stored in system 224, depending on the specific embodiment.

In one embodiment, verification that RFID enabled key 212 contains an authorized key can cause RFID lock 106 to open, however, in another embodiment other security steps can be necessary. For example, in step 308, information can be transmitted from RFID lock 106 to system 224. This information can be, e.g., as discussed above, position/location information. In one embodiment, RFID lock 106 can only be opened in one or more specified locations. In step 310, the information transmitted in step 308 can be verified, for example, it can be verified that RFID lock 106 is in a location where it can be opened. If this is the case, then in step 312, RFID lock 106 can be opened. It will be understood that the position/location information is only one possible example.

An RFID locking system has been described with respect to an example that used an RFID padlock to lock a shipping container. As discussed above, it will be understood that the systems and methods described herein can be used in almost any application that uses conventional door locks, padlocks, or other locking devices. As discussed above, examples include, car door locks, door locks, etc. In one aspect a door lock at a hotel, resort, cruise ship, etc. can use an RFID lock. For example, an RFID lock can be installed on the doors to one or more rooms at the hotel. When a guest checks into the hotel, an access card or a wrist band with an RFID tag embedded in it can be issued to the guest. The access card or wristband can be used to unlock the door to the guests room.

The access device can comprise any type of device that is RFID enabled so as to operate with the RFID lock, e.g., in the hotel room door. Thus, it will be understood that a card and a wristband are just two examples of RFID access devices that can be used in conjunction with the systems and methods described herein.

In certain embodiments, the RFID access device can also allow the hotel guest, or resort guest, cruise ship guest, theme park guest, etc., to access and/or pay for certain services or amenities in addition to unlocking the guests door, locker, etc., or allowing access to one or more rides. For example, the restaurants and shops can in the hotel can use a RFID reader to read the hotel guests RFID access device and charge the guest's room for any purchases. This can, for example, allow the guest to leave their money and/or wallet in their room when they go to the pool, but still allow the guest to access the services and amenities offered buy the hotel. This can reduce the risk of theft and increase convenience, which can drive increased sales.

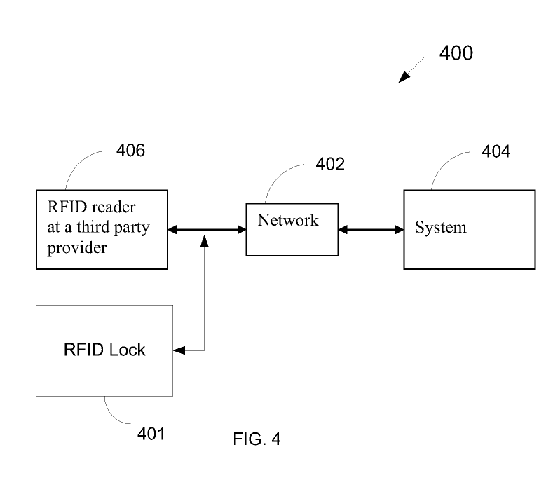

FIG. 4 is a diagram illustrating an example RFID locking system 400 that can also allow access to other services, etc., in accordance with another embodiment of the systems and methods described herein. In system 400, an RFID reader 401 included in a lock such as a hotel door lock can be configured to be opened by and RFID access device. In addition, RFID reader 401 can be in communication with system 404 via a network 402. System 404 can be similar to system 224, but in this case can store information such as when a guest has entered their room, when they have left etc. This information can be used, for example, to automatically turn on the lights, air conditioner, etc., upon the guests arrival to their room, or to schedule maid service upon their departure.

Third party readers 406, also configured to communicate with the guest's access device can also be in communication with system 404 via network 402 to allow the guest to make purchases and charge those purchases back to his or her room or cabin bill. For example, an RFID reader 406 can be located at a third party provider's location. A third party provider can include, for example, a gift shop, restaurant, or store, etc. The third party provider's location can be located in or near the hotel or resort or on the cruise ship, for example, and can be a separate business from the hotel, resort, or cruise line, or it can be affiliated with the hotel, resort, or cruise line in some way.

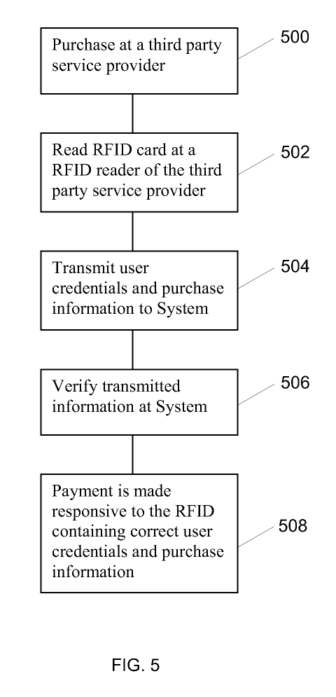

The third party provider's RFID reader 406 can be in communication with system 404 over network 402. Thus, any purchases that a guest at the hotel would like to make can be charged to the guests room using the guests RFID enabled key as is discussed further below with respect to FIG. 5.

It should be noted that RFID lock 401 and third party reader 406 can be configured to communicate over the same or different networks 402.

FIG. 5 is a flowchart illustrating an example method of paying a third party service provider in accordance with one embodiment of the systems and methods described herein. In step 500 a hotel guest can decide to make a purchase from a third party service provider. For example, the third party service provider's location can be a restaurant in the hotel that a guest is staying in.

The guest can present a staff member at the restaurant his or her RFID enabled room key. The room key can be read by an RFID reader located in the restaurant in step 502. The reader can read the data stored in the room key. This data can include, for example, room number, guest name, etc. The information contained in the RFID room key can be transmitted to system 404 in step 504 and once the information is verified in step 506 payment can be effectuated in step 508 responsive to the RFID enabled key containing the correct user credentials and purchase information.

While the example above has been discussed with respect to a hotel, as described in the discussion of FIG. 4, it will be understood that these systems and methods can also be applied to a resort, cruise ship, etc. Further, the third party provider's location can be almost any business commonly located at a hotel, resort, or on a cruise ship, etc. Additionally, the RF enabled room key can be, e.g., an access card, wrist band, etc.

While certain embodiments of the inventions have been described above, it will be understood that the embodiments described are by way of example only. Accordingly, the inventions should not be limited based on the described embodiments.

What is claimed is:

1 A Radio Frequency Identification (RFID) lock comprising:
a lock body;
a shackle, configured to be pressed into the lock body;
an electronic piston configured to lock the shackle into place, and an RFID Reader configured to control the electronic piston.

2. The lock of claim 1, further comprising an antenna coupled to the reader and configured to send and receive Radio Frequency (RF) signals.

3. The lock of claim 2, wherein the reader comprises an active device.

4. The lock of claim 3, wherein the reader transmits signals using the antenna.

5. The lock of claim 1, further comprising an internal power source.

6. The lock of claim 5, wherein the internal power source comprises a battery.

7. The lock of claim 1, further comprising a second antenna and transceiver.

8. The lock of claim 7, wherein the second antenna and transceiver are configured to implement a communication protocol.

9. The lock of claim 8, wherein the communication protocol comprises WIFI.

10. The lock of claim 8, wherein the communication protocol comprises GSM.

11. The lock of claim 8, wherein the communication protocol comprises GPS.

12. The lock of claim 8, wherein the communication protocol comprises GPRS.

13. The lock of claim 8, wherein the communication protocol comprises a combination of communication protocols.

14. A method for locking an RFID lock comprising:
locking an RFID lock;
reading an RFID enabled key reader using an RFID reader in the lock; and
verifying that the RFID enabled key contains an authorized key.

15. The method of claim 14, wherein the RFID lock is used to secure a shipping container.

16. The method of claim 14, wherein the RFID lock is used to secure a trailer.

17. The method of claim 14, wherein the RFID lock is used to secure a railroad car.

18. The method of claim 14, wherein the key is verified against data stored in the lock.

19. The method of claim 14, wherein the key is verified against data stored in a locking system.

20. The method of claim 14, further comprising:
transmitting information from the lock to an RFID lock system;
verifying the transmitted information; and
opening the lock responsive to the RFID containing an authorized key and the verified information.

21. The method of claim 20, wherein the information comprises position/location information.

22. The method of claim 21, wherein the lock can only be opened at a specified locations.
